(19) United States
(12) Patent Application Publication
(10) Pub. No.: US 2007/0132151 A1
(43) Pub. Date: Jun. 14, 2007

(54) Release agents and their use in the production of polyurethane moldings

(75) Inventors: Ralf Althoff, (US); Philippe Faure, (US); Torsten Henning, (US)

Correspondence Address: Leopold Presser;Scully, Scott, Murphy & Presser, 400 Garden City Plaza, Garden City, NY, 11530, US

(73) Assignee: Goldschmidt GmbH, Essen (DE)

(21) Appl. No.: 11/603,787

(22) Filed: Nov. 22, 2006

(30) Foreign Application Priority Data
Dec. 10, 2005 (DE) 10 2005 059 142.6

(51) Int. Cl. B28B 7/36

(52) U.S. Cl. 264/338; 106/38.22

(57) ABSTRACT

The invention relates to release agent dispersions for the production of polyurethane moldings, substantially containing A) at least one agent having a release activity selected from the group consisting of soaps, oils, waxes and silicones; B) talc; C) a thickener, and D) an organic solvent.

### FIELD OF THE INVENTION

The present invention relates to release agents and their use in the production of polyurethane moldings.

### BACKGROUND OF THE INVENTION

It is known that polyurethane systems used for the production of moldings show strong adhesion to the mold materials employed, preferably thermally highly conductive materials, such as metals. In the demolding of polyurethane moldings, release agents, which are applied to the mold walls that come into contact with polyurethanes and/or the polyurethane reaction mixture, are therefore required.

Such release agents consist of dispersions or emulsions of waxes, soaps, oils and/or silicones in solvents, such as hydrocarbons or water. After application of the release agent to the mold, the solvent evaporates and the non-volatile substances having release activity form a thin release film which is intended to ensure that the polyurethane molding can be easily removed from the mold after production.

In addition to the actually required release effect, the release agent also performs further functions; thus, it also greatly influences the surface of the polyurethane molding, which should be fine-pored or smooth and uniform, inter alia also for ensuring good coverability of the finished shaped articles with textiles or leather.

In the course of increasing optimization of the production speeds in the automobile supplier industry, it is precisely the above-described property of coverability of the polyurethane molding which has become an important quality feature. By using suitable polyether siloxane foam stabilizers and polyurethane catalysts, release agents according to the prior art give polyurethane moldings having a smooth surface, but these nevertheless show considerable resistance on covering with textile or leather.

One possibility for reducing the frictional resistances is to use solid lubricants, such as layered silicates or talc.

Attempts to dust the mold with talcum powder as an external release agent are known. The use of talc in powder form is, however, not suitable for use in production. A uniform release film is not produced in the mold, the working environment is greatly contaminated by powder dusts and it is not possible to include liquid additives in the formulation.

If an attempt is made to incorporate talc into classical, solvent-based release agents, the solid talc immediately sinks to the bottom within a few minutes after being stirred in, so that application by spraying of the release agent is no longer possible. Stirring up the mixture shortly before spraying is also not possible since the unstable mixture separates during transport through the thin pipelines to the nozzle and blocks the pipes with talc.

U.S. Pat. No. 4,131,662 describes a suspension of talc, stabilized in an aqueous emulsion with a low molecular weight organic material (molecular weight of 200 or lower) preferably toluene, as a mold release active substance, together with an organic solvent which is miscible with the low molecular weight organic material, preferably dichloromethane.

However, the water present in this formulation does not volatilize completely at the usual mold temperatures of from 45° to 80° C., preferably from 50° to 75° C., and a thin water film always remains on the mold surface. The isocyanate compounds of the polyurethane system undergo, with this water, reactions which lead to very rigid polyurea compounds. Consequently, the mold surfaces are adversely affected, acquiring a so-called build-up and have to be cleaned by a complicated method.

It is therefore an object of the present invention to provide mold release agents which are stable, show a good release effect and advantageously influence the surfaces of polyurethane moldings. The molding surface should be fine-pored, uniform and smooth and should be capable of being covered quickly with application of little force. In addition, the release agent should leave behind no polyurea build-up on the mold surface.

### SUMMARY OF THE INVENTION

The present invention provides mold release agents which are stable, show a good release effect and advantageously influence the sure of polyurethane moldings. The molding surface that are obtained using the inventive mold release agents are fine-pored, uniform and smooth and are quickly covered with application of little force. Additionally, the release agents of the present invention leave behind no polyurea build-up on the mold surfaces.

Surprisingly, it has been found by the present applicants that a dispersion of classical substances having a release activity, such as waxes, soaps, oils and/or silicones, in organic solvents in combination with talc, together with thickeners, achieve the above.

The present invention therefore relates to release agent dispersions for the production of polyurethane moldings, substantially containing

A) at least one agent having release activity selected from the group consisting of soaps, oils, waxes and silicones;

B) talc;

C) a thickener, and

D) an organic solvent

The dispersions of the present invention preferably consist of

A) from 0.5 to 40% by weight of at least one agent having release activity selected from the group consisting of soaps, oils, waxes and silicones;

B) from 0.1 to 15% by weight of talc;

C) from 0.05 to 10% by weight of thickeners;

D) from 0.1 to 10% by weight of auxiliaries and additives;

E) and solvent to 100% by weight

The inventive dispersions more preferably consist of

A) from 0.5 to 40% by weight of at least one agent having release activity selected from the group consisting of soaps, oils, waxes and silicones;

B) from 0.1 to 15% by weight of talc;

C) from 0.05 to 10% by weight of silica;

D) from 0.1 to 5% by weight of catalysts;

E) from 0.1 to 5% by weight of foam stabilizers; and

F) solvent to 100% by weight

The invention also relates to the use of these release agents in the production of polyurethane moldings.

The present invention even further relates to the use of the inventive release agent dispersion for improving the coverability of polyurethane moldings, produced with the aid of the release agents described, with fabrics, textiles, nonwovens, leather or other covering materials for automobile seats, upholstered furniture or mattresses.

### DETAILED DESCRIPTION OF THE INVENTION

As stated above, the present invention provides mold release agents which are stable, show a good release effect and advantageously influence the surfaces of polyurethane moldings. The molding surfaces that are obtained using the inventive mold release agents are fine-pored, uniform and smooth and are quickly covered with application of little force. Additionally, the release agents of the present invention leave behind no polyurea build-up on the mold surface.

In accordance with the present invention, the release agents comprise at least one agent having release activity selected from the group consisting of soaps, oils, waxes and silicones; talc; thickener, and an organic solvent.

Each of the components used in the inventive release agents will know be described in further detail.

Inorganic minerals from the family consisting of the layered silicates, also referred to as phyllosilicates, which mainly comprise magnesium silicate and various impurities, such as chlorite or other accompanying materials, are designated as talc. Mica, i.e., layered silicates, which contain large cations, such as K⁺, Na⁺ or Ca²⁺, is also suitable for use in the preset invention.

Talc having a composition of from 35 to 70% by weight of SiO₂, from 5 to 40% by weight of MgO, from 1 to 20% by weight of Al₂O₃ and from 1 to 5% by weight of Fe₂O₃ is preferably used Lamellar talc having a composition of from 40 to 50% by weight of SiO₂, from 25 to 35% by weight of MgO, from 7 to 12% by weight of Al₂O₃, from 1.5 to 2.5% by weight of % Fe₂O₃ and from 1 to 2% by weight of CaO is more preferably used.

Suitable talc products are sold, for example, under the trade names Luzenac®, Mistron®, French Velvet®, Ultrapure Talc®.

A large part of the talc is transferred to the polyurethane molding during the demolding of the molding and leads to a very smooth, outstandingly covetable surface.

The silica used is preferably pyrogenic silica having an SiO₂ content, based on substance ignited at 1000° C. for 2 hours, of greater than 99%. The preferred particle size of the silica is less than 40 microns. The preferred specific surface area (BET) is greater than 50 m²/ g, more preferably greater than 100 m²/g.

Suitable silica is sold, for example, under the trade names Aerosil®, for example Aerosil® 200, Aerosil® R 805, Aerosil® R 972 or Wacker HDK®, for example Wacker HDK® H 15, or Neosil®.

The silica produces a flow yield point in the solvent matrix and thus stabilizes the solid talcum powder, prevents sinking and permits spray application of the release agent

According to the invention, the following can, for example, be used as classical substances having release activity:

Waxes, i.e., liquid, solid, natural or synthetic waxes, also oxidized and/or partially hydrolyzed, esters of carboxylic acids with alcohols or fatty alcohols; metal soaps, such as alkali metal or alkaline earth metal salts of fatty acids; oils, such as hydrocarbons which are liquid or viscous at room temperature, optionally but not preferably, with concomitant use of unsaturated oligomeric and/or polymeric hydrocarbons; and silicones, such as polydimethylsiloxanes, optionally substituted by aliphatic or aromatic hydrocarbon radicals.

Typical waxes having release activity are mentioned, for example, in the company brochures “Waxes by Clariant, production, characteristics and applications” Clariant May 2003 and “Formtrennmittel Vestowax® [Mold release agents with Vestowax®]”, Degussa February 2001.

One or more compounds selected from the group consisting of
A) catalysts:
those which are typically used for the polyurethane reaction, for example Lewis acids, such as tin compounds or Lewis bases, such as tertiary amines;
B) foam stabilizers:
polysiloxane/polyether copolymers
   may be used as customary auxiliaries and additives.

Solvents which may preferably be used are solvents which are free of CFCs (chlorofluorocarbons). Preferably, hydrocarbons having a boiling range of from 25° to 280° C., preferably from 80° to 200° C., preferably having flashpoints greater than 22° C., more preferably greater than 55° C., are used.

Examples of suitable solvents that can be employed in the present invention are special boiling point spirit 100/140, Shelsol® D 40 or Exxsol® D 40; mixtures of isoundecane/isododecane as examples for isoparaffin “crystal oil K 30” as example for white spirits.

The dispersions according to the invention can be prepared by processes known in the prior art. In the preferred procedure, the substances having release activity are initially introduced in molten form, or part of the solvent is introduced under high shear force and then the remaining solvent, together with talc, silica and the further components is added with a low shear force. In a preferred embodiment of the present invention, the remaining solvent is first thickened with the silica as a gel and then added together with the talc with a low shear force.

The invention furthermore relates to the use of release agents described in the production of polyurethane moldings.

Classically, the mold is brought to the desired mold temperature of from 45° to 80° C., preferably from 50° to 75° C., and sprayed with release agent, a certain time is allowed to pass until the major amount of solvent has evaporated, and the reactive polyurethane system comprising polyols, polyisocyanates and optionally further additives, such as catalysts, foam stabilizers and blowing agents, is then pumped in. The mold is closed and, after the curing time, the mold is opened and the shaped article is removed.

The invention furthermore relates to the covering of the polyurethane moldings, produced, as described above, with the aid of the release agents described above, with fabrics, textiles, nonwovens, leather or other covering materials, for example for automobile seats, upholstered furniture or mattresses.

The inventive release agent described is also particularly suitable for moldings comprising viscoelastic polyurethane foams, whose typically tacky surface can be handled in drier form more easily as a result of the layered silicate.

The following examples are provided to illustrate some aspects of the present invention

List of substances used:
Microwax=commercially available waxes having a solidification temperature of from 50° to 90° C.,
polyethylene wax=commercially available waxes having a solidification temperature of from 50° to 90° C.,
hydrocarbon =commercially available spirit fractions having a boiling range of from 80° to 200° C.,
Luzenac® 2=lamellar talc comprising 46.0% by weight of SiO₂, 30.5% by weight of MgO, 9.8% by weight of Al₂O₃, 2.1% by weight of Fe₂O₃, 1.4% by weight of CaO, manufacturer. Luzenac,
Aerosil® R 972=pyrogenic silica, having an SiO₂ content, based on substance ignited at 1000° C. for 2 hours of greater than 99.7%, particle size: not more than 0.06% greater than 40 microns, specific surface area (BET) 100 m²/g, manufacturer Degussa,
Kosmos® 19=dibutyltin dilaurate (DBTL), manufacturer: Degussa,
DC® 190=polyethersiloxane, manufacture: Air Products,
Desmophen(® PU 21IK01=polyetherpolyol, manufacture Bayer,
Tegoamin® TA 33, manufacturer Degussa,
Tegoamin® AS-1, manufacturer Degussa,
Tegostab® EP-K-38=organomodified siloxane, manufacturer: Degussa,
Suprasec® 2412=diphenylmethane 4,4′-diisocyanate, manufacturer: Huntsman

### EXAMPLE 1

2.5% by weight of polyethylene wax (solidification point 60° C.) and 2.5% by weight of microwax (solidification point 70° C.) were melted, and 45% by weight hydrocarbon (flashpoint 23° C.) were added 46.3% by weight of hydrocarbon (flashpoint 23° C.) were thickened with 0.2% by weight of Aerosil® R 972, 2% by weight of Luzenac® 2 and 0.5% by weight of Kosmos® 19 and 1% by weight of DC® 190 were added and the mixture was added to the wax dispersion.

### EXAMPLE 2

2.5% by weight of polyethylene wax (solidification point 60° C.) and 2.5% by weight of microwax (solidification point 70° C.) were melted, and 45% by weight hydrocarbon (flashpoint 56° C.) were added 44.25% by weight of hydrocarbon (flashpoint 560C) were thickened with 0.5% by weight of Aerosil® R 972, 3.5% by weight of Luzenac® 2 and 0.5% by weight of Kosmos® 19 and 1% by weight of DC® 190 were added and the mixture was added to the wax dispersion.

### EXAMPLE 3

2% by weight of polyethylene wax (solidification point 60° C.) and 2% by weight of microwax (solidification point 70° C.) were melted, and 45% by weight hydrocarbon (flashpoint 56° C.) were added. 40.4% by weight of hydrocarbon (flashpoint 56° C.) were thickened with 1.5% by weight of Aerosil® R 972, 8% by weight of Luzenac® 2 and 0.3% by weight of Kosmos® 19 and 0.8% by weight of DC® 190 were added and the mix was added to the wax dispersion.

### Comparative Example A

### Classical Release Agent

2.5% by weight of polyethylene wax (solidification point 60° C.) and 2.5% by weight of microwax (solidification point 70° C.) were melted, and 45% by weight of hydrocarbon (flashpoint 56° C.) were added. 0.5% by weight of Kosmos® 19 and 1% by weight of DC® 190 were added to 48.5% of hydrocarbon (flashpoint 56° C.) and the mixture was added to the wax dispersion.

Release Agent Experiments:

The release agents were sprayed on to test metal plates by means of a 0.5 mm nozzle in amounts of 20 g/m² similar to those used in practice, and a foamable polyurethane system consisting of 100 parts of Desmophen® PU 21IK01, 3.5 parts of water, 0.4 part of Tegoamin® TA 33, 0.25 part of Tegoamin® AS-1, 0.7 part of diethanolamine, 0.5 part of Tegostab® EP-K-38, 0.2 part of acetic acid (60% in water), and 63.5 parts of Suprasec® 2412 was foamed on these plates in a box mold at 55° C.

After curing (10 minutes), the metal plates were peeled off from the foam and the foam surface was then assessed. The coverability was measured as sliding friction by means of a weight (100 g, area 24 cm²) which is mounted on a spring balance, covered with textile and drawn over the foam.

Evaluation of the Release Experiments:

| | | Max. force for drawing |
|---|---|---|
| | | 100 g weight having |
| | | an area of 24 cm² |
| Release | | over foam surface |
| agent | Assessment of foam surface | [kg] |
| 1 | slightly closed, dry | 8 |
| 2 | closed, dry | 6 |
| 3 | closed, dry | 5 |
| A | fine-pored, open, dry | 12 |

While the present invention has been particularly shown and described with respect to preferred embodiments thereof; it will be understood by those skilled in the art that the foregoing and other changes in forms and details may be made without departing from the spirit and scope of the present invention. It is therefore intended that the present invention not be limited to the exact forms and details described and illustrated, but fill within the scope of the appended claims.

What is claimed is:

1. A release agent dispersion for the production of polyurethane moldings comprising:
A) at least one agent having release activity selected from the group consisting of soaps, oils, waxes and silicones;
B) talc;
C) a thickener; and
D) an organic solvent.

2. The dispersion as claimed in claim 1, consisting of
A) from 0.5 to 40% by weight of said at least one agent having release activity;
B) from 0.1 to 15% by weight of talc;
C) from 0.05 to 10% by weight of thickeners;
D) from 0.1 to 10% by weight of auxiliaries and additives; and
E) solvent to 100% by weight.

3. The dispersion as claimed in claim 1, consisting of
A) from 0.5 to 40% by weight of said at least one agent having release activity;
B) from 0.1 to 15% by weight of talc;
C) from 0.05 to 10% by weight of silica;
D) from 0.1 to 5% by weight of catalysts;
E) from 0.1 to 5% by weight of foam stabilizers; and
F) solvent to 100% by weight.

4. The dispersion as claimed in claim 1, wherein said talc comprises a layered silicate.

5. The dispersion as claimed in claim 1, wherein said talc has a composition of from 35 to 70% by weight of SiO₂, from 5 to 40% by weight of MgO, from 5 to 20% by weight of Al₂_{O}₃ and from 1 to 5% by weight of Fe₂O₃.

6. The dispersion as claimed in claim 3, wherein said silica is pyrogenic silica having an SiO₂ content, based on substance ignited at 1000° C. for 2 hours, of greater than 99%.

7. A method for producing a polyurethane molding comprising adding at least a dispersion of claim 1 to surfaces of a mold prior to adding a reactive polyurethane system to said mold.

8. The method as claimed in claim 7, wherein said mold is heated prior to adding the dispersion to said mold.

9. The method as claimed in claim 7, wherein said mold is heated to a temperature from 45° to 80° C.

10. The method as claimed in claim 7, consisting of
A) from 0.5 to 40% by weight of said at least one agent having release activity;
B) from 0.1 to 15% by weight of talc;
C) from 0.05 to 10% by weight of thickeners;
D) from 0.1 to 10% by weight of auxiliaries and additives; and
E) solvent to 100% by weight.

11. The method as claimed in claim 7, consisting of
A) from 0.5 to 40% by weight of said at least one agent having release activity;
B) from 0.1 to 15% by weight of talc;
C) from 0.05 to 10% by weight of silica;
D) from 0.1 to 5% by weight of catalysts;
E) from 0.1 to 5% by weight of foam stabilizers; and
F) solvent to 100% by weight.

12. The method as clamed in claim 7, wherein said talc comprises a layered silicate.

13. The method as claimed in claim 7, wherein said talc has a composition of from 35 to 70% by weight of SiO₂, from 5 to 40% by weight of MgO, from 5 to 20% by weight of Al₂O₃ and from 1 to 5% by weight of Fe₂O₃.

14. The method as claimed in claim 11, wherein said silica is pyrogenic silica having an SiO₂ content, based on substance ignited at 1000° C. for 2 hours, of greater than 99%.
